(19) United States
(12) Patent Application Publication
(10) Pub. No.: US 2024/0348782 A1
(43) Pub. Date: Oct. 17, 2024

(54) METHODS FOR CONTEXT-BASED VIDEO CODING

(71) Applicant: Alibaba Innovation Private Limited, Singapore (SG)

(72) Inventors: Ru-Ling LIAO, Beijing (CN); Yan YE, San Diego, CA (US); Jie CHEN, Beijing (CN); Xinwei LI, Beijing (CN)

(21) Appl. No.: 18/628,723

(22) Filed: Apr. 6, 2024

Related U.S. Application Data
(60) Provisional application No. 63/496,012, filed on Apr. 13, 2023.
(60) Provisional application No. 63/618,884, filed on Jan. 8, 2024.

(51) Int. Cl. H04N 19/13; H04N 19/174; H04N 19/91

(52) U.S. Cl. CPC H04N 19/13; H04N 19/174; H04N 19/91

(57) ABSTRACT

Methods and apparatuses are provided for initializing a set of context model probability for a slice in context-based adaptive binary arithmetic coding (CABAC). An exemplary video decoding method includes: selecting, from a plurality of predefined sets of probability parameters, a first set of probability parameters for initiating one or more context models for a B-slice; and performing entropy decoding of the B-slice based on the one or more context models and the first set of probability parameters, wherein the selecting is based on a coding condition of the B-slice or a signal in the bitstream.

### CROSS REFERENCE TO RELATED APPLICATIONS

This application is based upon and claims priority to U.S. Provisional Patent Application No. 63/496,012, filed Apr. 13, 2023, and U.S. Provisional Patent Application No. 63/618,884, filed Jan. 8, 2024, the contents of all which are incorporated herein by reference in their entireties.

### TECHNICAL FIELD

The present disclosure generally relates to video processing, and more particularly, to methods and apparatuses for initializing a set of context model probability for a slice in context-based adaptive binary arithmetic coding (CABAC).

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide methods and apparatuses for initializing a set of context model probability for a slice in context-based adaptive binary arithmetic coding (CABAC).

According to some exemplary embodiments, there is provided a decoding method including: selecting, from a plurality of predefined sets of probability parameters, a first set of probability parameters for initiating one or more context models for a B-slice; and performing entropy decoding of the B-slice based on the one or more context models and the first set of probability parameters, wherein the selecting is based on a coding condition of the B-slice or a signal in the bitstream.

According to some exemplary embodiments, there is provided an encoding method including: selecting, from a plurality of predefined sets of probability parameters, a first set of probability parameters for initiating one or more context models for a B-slice; and performing entropy encoding of the B-slice based on the one or more context models and the first set of probability parameters, wherein the selecting is based on a coding condition of the B-slice or a signal in the bitstream.

According to some exemplary embodiments, there is provided a non-transitory computer readable storage medium storing a bitstream of a video. The bitstream includes: selecting, from a plurality of predefined sets of probability parameters, a first set of probability parameters for initiating one or more context models for a B-slice; and performing entropy encoding or decoding of the B-slice based on the one or more context models and the first set of probability parameters, wherein the selecting is based on a coding condition of the B-slice or a signal in the bitstream.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an example video sequence, according to some embodiments of the present disclosure.

FIG. 2A is a schematic diagram illustrating an exemplary encoding process of a hybrid video coding system, according to some embodiments of the present disclosure.

FIG. 2B is a schematic diagram illustrating another exemplary encoding process of a hybrid video coding system, according to some embodiments of the present disclosure.

FIG. 3A is a schematic diagram illustrating an exemplary decoding process of a hybrid video coding system, according to some embodiments of the present disclosure.

FIG. 3B is a schematic diagram illustrating another exemplary decoding process of a hybrid video coding system, according to some embodiments of the present disclosure.

FIG. 4 is a block diagram of an exemplary apparatus for encoding or decoding a video, according to some embodiments of the present disclosure.

FIG. 5 is a schematic diagram illustrating a context-based adaptive binary arithmetic coding (CABAC) engine, according to some embodiments of the present disclosure.

FIG. 6 illustrates an exemplary table of codewords used for binary coding, according to some embodiments of the present disclosure.

FIG. 7 illustrates an exemplary process for updating the Range and Low variables in a binary arithmetic encoding (BAE) stage of the CABAC engine of FIG. 5, according to some embodiments of the present disclosure.

FIG. 8 illustrates an exemplary process for updating the Range and Low variables in the BAE stage of the CABAC engine of FIG. 5, according to some embodiments of the present disclosure.

FIG. 9 illustrates an exemplary set of context model probability parameters, according to some embodiments of the present disclosure.

FIG. 10 illustrates another exemplary set of context model probability parameters, according to some embodiments of the present disclosure.

FIG. 11 illustrates four exemplary sets of context model probability parameters, according to some embodiments of the present disclosure.

FIG. 12 illustrates a flowchart of an exemplary method for decoding a bitstream associated with a video, according to some embodiments of the present disclosure.

FIG. 13 illustrates a flowchart of another exemplary method for decoding a bitstream associated with a video, according to some embodiments of the present disclosure.

FIG. 14 illustrates a flowchart of an exemplary method for encoding a bitstream associated with a video, according to some embodiments of the present disclosure.

FIG. 15 illustrates a flowchart of another exemplary method for encoding a bitstream associated with a video, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms or definitions incorporated by reference.

The present disclosure provides methods for initiating the probability parameters of context models for use in context-based adaptive binary arithmetic coding (CABAC). According to some disclosed embodiments, the initial probability parameters can be selected from a plurality of predefined sets of probability parameters. In some embodiments, the plurality of predefined sets of probability parameters can be prestored at the encoder and decoder, and the selection can be derived at both the encoder and decoder without explicit signaling. In some embodiments, the plurality of predefined sets of probability parameters can be prestored at the encoder and decoder, and the selection can be signaled in a bitstream. In some embodiments, the initial probability parameters can be selected without referring to the previously coded pictures. In some embodiments, the initial probability parameters can be selected based on the content of the current slice to which the CABAC is applied.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

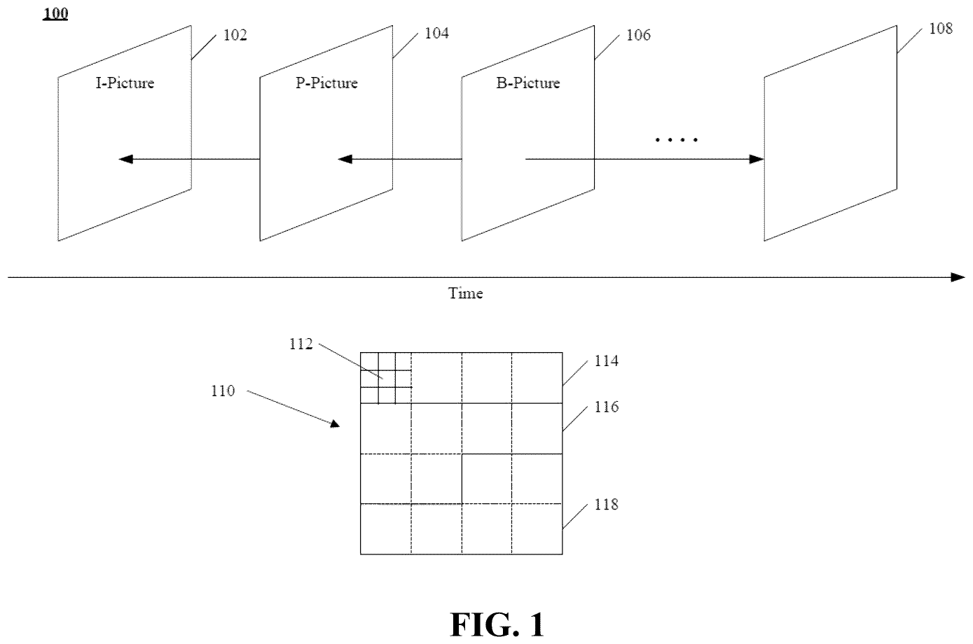

FIG. 1 illustrates structures of an example video sequence 100, according to some embodiments of the present disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

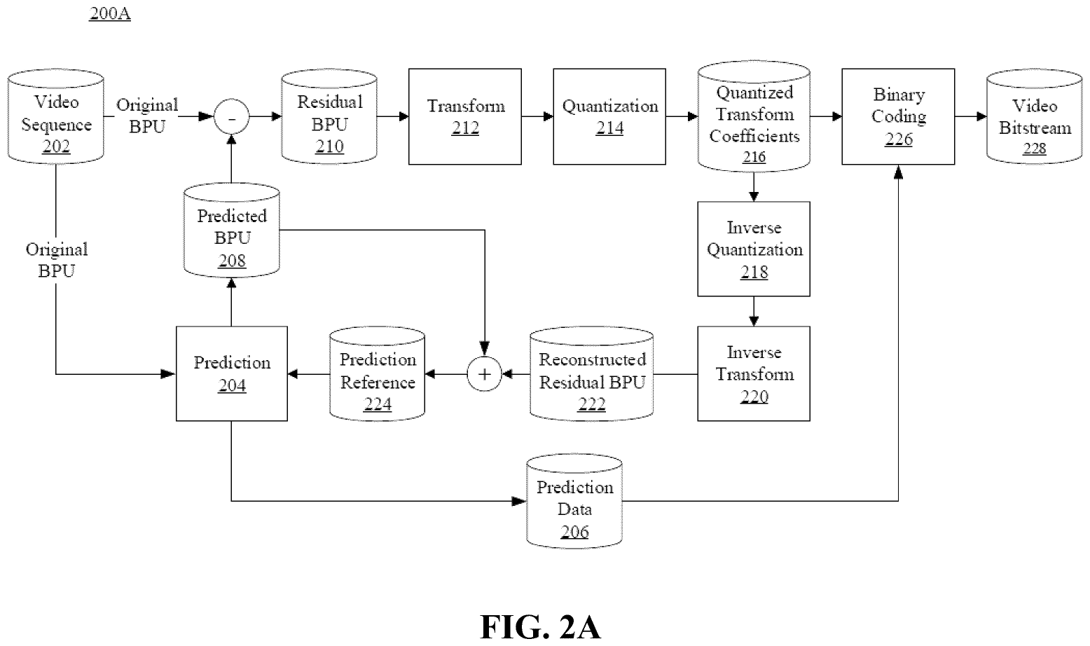

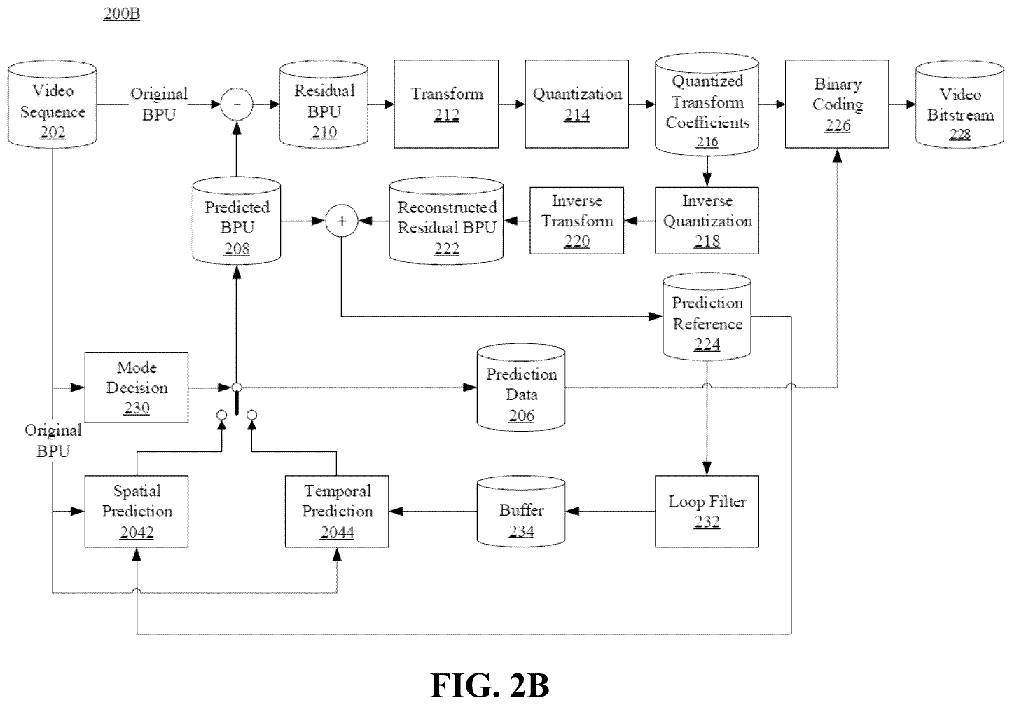

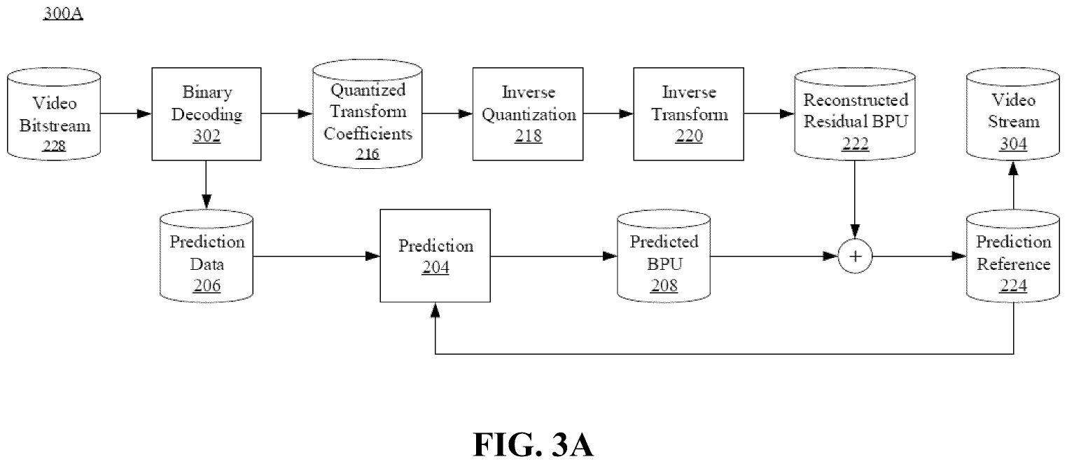

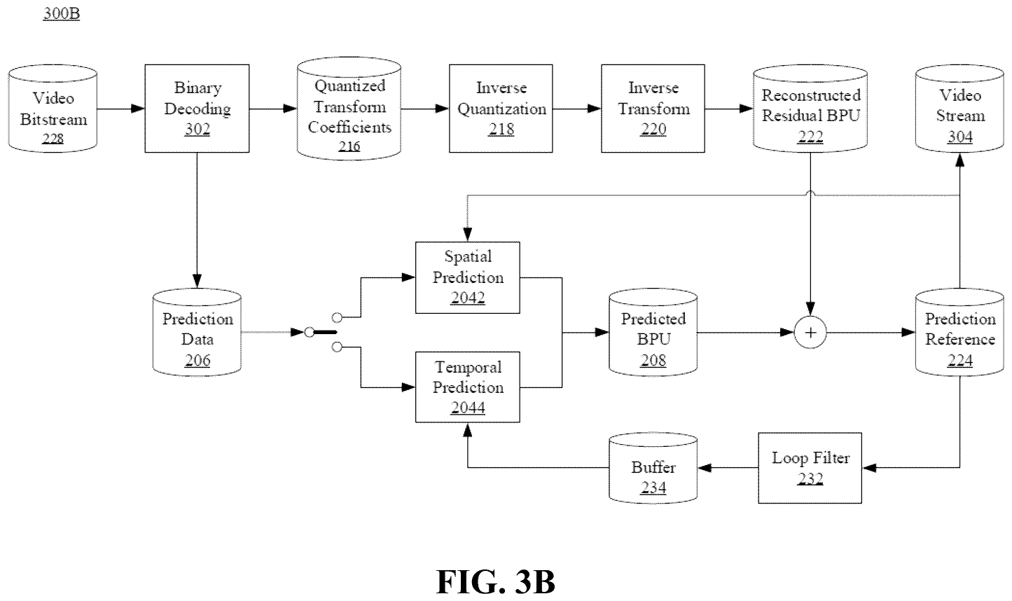

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC) and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIGS. 2A-2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an example encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224 and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, context-adaptive binary arithmetic coding (CABAC), entropy coding, variable length coding, arithmetic coding, Huffman coding, or any other lossless or lossy compression algorithm.

For example, the encoding process of CABAC in binary coding stage 226 may include a binarization step, a context modeling step, and a binary arithmetic coding step. If the syntax element is not binary, the encoder first maps the syntax element to a binary sequence. The encoder may select a context coding mode or a bypass coding mode for coding. In some embodiments, for context coding mode, the probability model of the bin to be encoded is selected by the “context”, which refers to the previous encoded syntax elements. Then the bin and the selected context model is passed to an arithmetic coding engine, which encodes the bin and updates the corresponding probability distribution of the context model. In some embodiments, for the bypass coding mode, without selecting the probability model by the “context,” bins are encoded with a fixed probability (e.g., a probability equal to 0.5). In some embodiments, the bypass coding mode is selected for specific bins in order to speed up the entropy coding process with negligible loss of coding efficiency.

In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another example encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets (SAO), adaptive loop filters (ALF), or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an example decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., CABAC, entropy coding, variable length coding, arithmetic coding, Huffman coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another example decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include parameters of the loop filter (e.g., a loop filter strength). In some embodiments, prediction data includes parameters of the loop filter when the prediction mode indicator of prediction data 206 indicates that inter prediction was used to encode the current BPU.

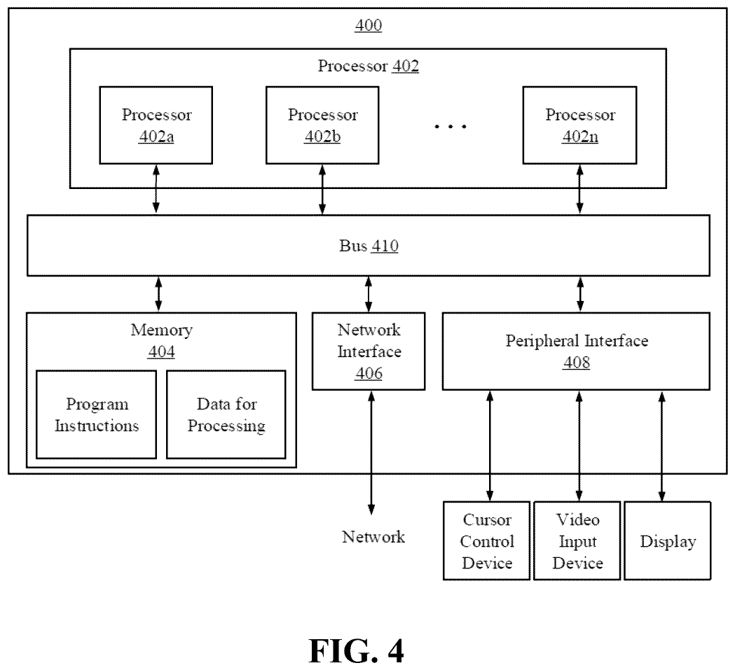

FIG. 4 is a block diagram of an example apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

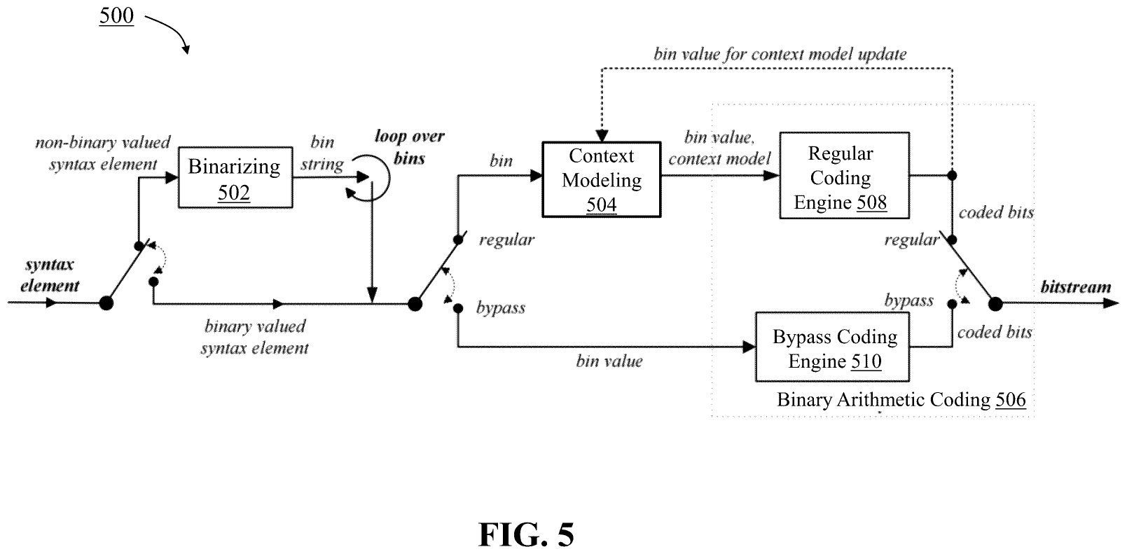

The present disclosure provides methods for initializing the probabilities of context models used in CABAC. FIG. 5 is a schematic diagram illustrating a context-based adaptive binary arithmetic coding (CABAC) engine 500, according to some embodiments of the present disclosure. Consist with the disclosed embodiment, CABAC engine 500 can be used by an encoder to conduct binary coding, For example, CABAC engine 500 can be used at binary coding stage 226 in FIG. 2A or FIG. 2B.

Referring to FIG. 5, CABAC engine 500 includes three elementary stages: binarizing 502, context modeling (CM) 504, and binary arithmetic encoding (BAE) 506.

Binarizing 502 is a data pre-processing procedure. In the binarizing 502, non-binary syntax elements are coded into a string of binary symbols called “bins.” An individual binary symbol is referred to as simply a bin. Various methods can be used to binarize the input syntax elements, such as table mapping, unary coding, truncated unary coding, fixed length coding, unary exponential Golomb k-th order (UEG-k) coding, etc.

As an example, UEG-k can be used to binarize motion vector differences as follows. In this example, it is assumed that the value mvd of a motion vector component is given. For the prefix part of the UEG-k bin string, a TU binarization with a cutoff value of S=9. If mvd is equal to zero, the bin string only includes the prefix code word “0”. If the condition |mvd|≥9 holds, the suffix is constructed as an EG3 codeword for the value of |mvd|-9, to which the sign of mvd is appended using the sign bit “1” for a negative mvd and the sign bit “0” otherwise. For mvd values with 0<|mvd|<9, the suffix only includes the sign bit. It is noted that the component of a motion vector difference represents the prediction error at quarter-sample accuracy, the prefix part corresponds to a maximum error component of +2 samples. With the choice of the Exp-Golomb parameter k=3, the suffix code words are given such that a geometrical increase of the prediction error in units of 2 samples is captured by a linear increase in the corresponding suffix code word length.

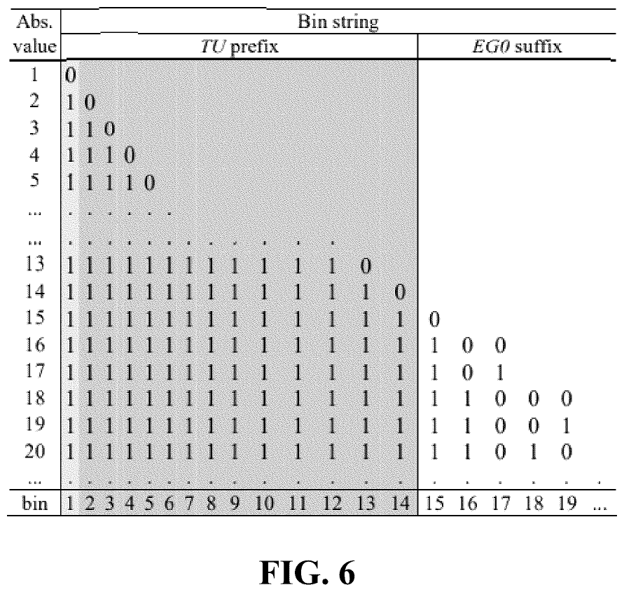

UEG-k binarization of absolute values of transform coefficient levels (abs_level) is specified by the cut-off value S=14 for the TU prefix part and the order k=0 for the EGk suffix part. It is noted that the binarization and subsequent coding process is applied to the syntax element coeff_abs_value_minus1=abs_level−1, since zero valued transform coefficient levels are encoded using a significance map. The construction of a bin string for a given value of coeff_abs_value_minus1 is similar to the construction of UEG-k bin strings for the motion vector difference components except that no sign bit is appended to the suffix. The table in FIG. 6 shows the corresponding bin strings for values of abs_level from 1 to 20, where the prefix parts are highlighted in gray shaded columns.

Referring back to FIG. 5, context modeling 504 computes a context index (ctxIdx) for each bin. This context index is used to find a context model that is stored as the probability state tables. These tables are updated with each bin and reinitialized at the start of each slice.

For example, a number (e.g., 399) of context models can be stored at the encoder. A context index (ctxIdx) is used to track the sum of the context index offset (ctxIdxOffset) and the context index increment (ctxIdxInc). The exception to the above implementation is the calculation of the context index for residual syntax elements, where it is the sum of ctxIdxOffset, ctxIdxInc and context block category offset (ctxBlockCatOffset). The ctxBlockCatOffset depends on the context block category of the macroblock presently being encoded. The ctxIdxOffset is determined by the syntax element type and slice type. The ctxIdxInc differs for each bin of the coded syntax element, so it is dependent on the index of the bin or bin index (binIdx). The calculation of the ctxIdxInc is dependent upon neighbor information in some of the cases. For residual syntax elements, the ctxIdxInc calculation also depends upon the scanning position of the current element being coded and upon the number of previously encoded coefficients.

Each bin value and its corresponding ctxIdx is sent to binary arithmetic encoding module 506. Binary arithmetic encoding module 506 stores information such as most probable symbol (MPS), and the probability of that state. This consists of the context information that can be accessed with the ctxIdx. In binary arithmetic encoding module 506, there are two possible symbols, namely, 0 and 1. If one of the symbols is the most probable symbol, then the other symbol becomes the least probable symbol (LPS). A context memory or context table can be employed to store the context information consisting of probability state index and value of most probable state (e.g., ranging from 0-399).

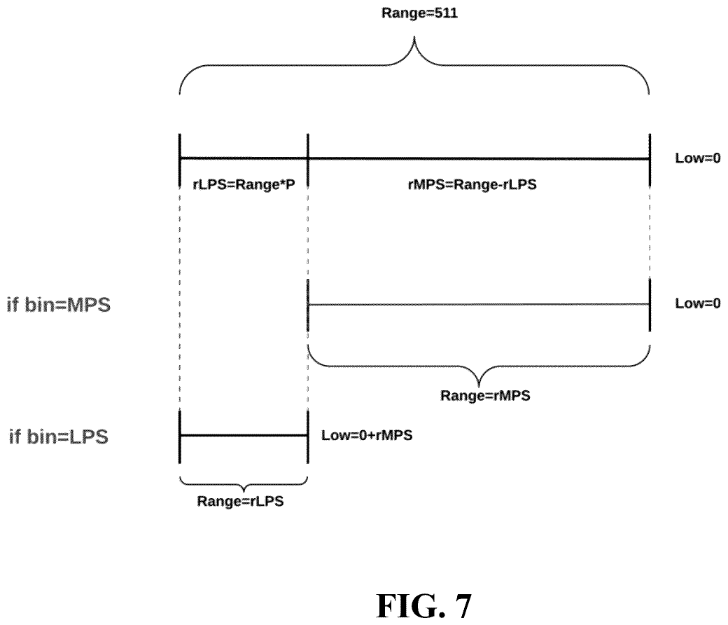

Regular coding engine 508 performs arithmetic coding, in which a coding interval is setup and updated based on the probability of MPS and LPS. The code word of arithmetic coding is generated from recursively dividing the interval. Two variables are used to keep track of the interval: the Low variable and the Range variable, which are referred to as codILow and codIRange respectively. FIG. 7 shows the Range and Low values, and when they are updated.

The initial value of the Range is 510 and it is a 9-bit register. The initial value of the Low is 0 and it is a 10-bit register. rMPS and rLPS represents the two corresponding sub-intervals of MPS and LPS, respectively. If input bin is equal to MPS, rMPS is chosen as the new interval, otherwise rLPS is selected. When the updated Range is found to lie outside the interval 256 and 511 inclusive, a renormalization procedure is employed. The renormalization procedure is where most of the code word is constructed.

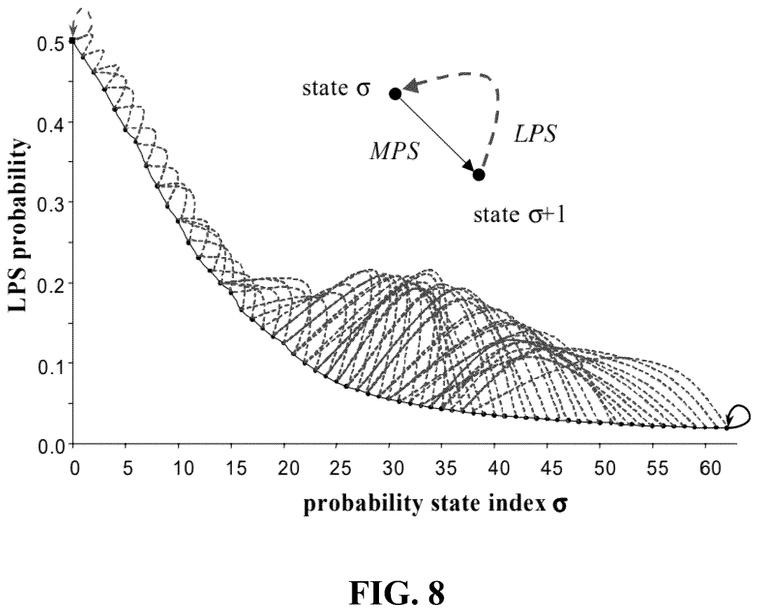

The probability state PLPS is needed for computing the rLPS value. This value ranges from 0 to 0.5 and it is quantized to 64 discrete probability states. These states are indexed by a variable pStateIdx ranging from 0 to 63. The transition to next state based on the current bin is shown in FIG. 8. A lookup table is used to update the probability state.

As another multiplication operation in this stage, the computation of rLPS=Range*R_{LPS}, is also converted to a lookup table. The Range is quantized to four R_{Q} values. The product rLPS is also quantized to 256 values based on R_{Q} and pStateIdx. As a result, computing of rLPS can be simply done by looking up in a two-dimension table, in which R_{Q} and pStateIdx are the two indices.

Two other coding methods are also used in the binary arithmetic coding. In bypass coding engine 510, the context modeler stage is bypassed. This means that the previous values of Range and Low are used and the renormalization for the bypass method is invoked. In the bypass coding engine, the probability of the two symbols is considered to be equal to 0.5.

Moreover, a terminate coding engine (not shown in FIG. 5) can be invoked when the end of slice syntax element is encountered or when the mb type is of the IPCM variety. Here also no context model is chosen. The LPS is fixed to 1 and the rLPS is fixed to 2. Otherwise, the renormalization is the same. When the end of a slice is encountered, then there is also a flushing algorithm that is called.

Every time a new slice begins, an initialize algorithm is invoked which resets all the 399 context models, based on the slice type and the cabac init idc value. The slice QP variable is used to compute the exact context.

The above CABAC engine 500 (FIG. 5) is described in connection with an encoder. It is understood that inverse operations of CABAC engine 500 can be performed at binary decoding stage 302 (FIG. 3A or FIG. 3B) of a decoder.

In VVC, the probability of each context model in context-based adaptive binary arithmetic coding (CABAC) engine is initialized according to slice type (i.e., I-slice, P-slice, B-slice). When encoding or decoding a bin, the probability of context model is updated. To improve the accuracy of probability estimation, a multi-hypothesis probability update model is supported. Two probabilities are associated with each context model and are updated independently with different adaptation rates. The adaptation rates of the probabilities for each context model are pre-trained based on the statistics of the associated bins. The probability used for coding a bin is the average of the estimates from the two hypotheses.

In the Enhanced Compression Model (ECM), which is used to further improve the coding performance of the VVC standard, the multi-hypothesis probability update model is further improved. The adaptation rates of the two probabilities associated with each context model are different for each slice type and are initialized according to the slice type. Moreover, to improve the accuracy of the probability estimation for varying statistic in different regions, the adaptation rates are adjusted by two delta parameters in a look-up table per context and retrieved by a previous coded bin used as an index. The previous coded bin is used as an index to get the adjustment parameters from a look-up table. Moreover, the simple averaging of the two probability is extended to weighted averaging. Three different sets of weights are pre-determined for each context model at I-, B- and P-slice types.

In ECM, for inter slices (i.e., B- and P-slices), the probability of context model can be predicted from previous coded pictures having the same slice type, QP and temporal ID.

In the current ECM design, the probability of each context model is initialized according to the slice type or is predicted from the previous coded pictures. However, this may not be optimal since each picture may have different content. The present disclosure provides methods to solve this problem.

In some embodiments, it is proposed to independently select a set of context model probability from a plurality of sets of context model probability for each slice. The plurality of sets of context model probability contain N sets, wherein N is a positive integer number. A set of context model probability may contain any subset of {initial probability, adaptation rates, weights applied to two probabilities and adjustment parameters}. For each slice, selecting a set of context model probability from the plurality of sets of context model probability may be based on slice type, QP, temporal ID, low delay condition, rate cost and etc. The selection may be derived at both encoder and decoder without signaling. The selection may also be signaled in bitstream.

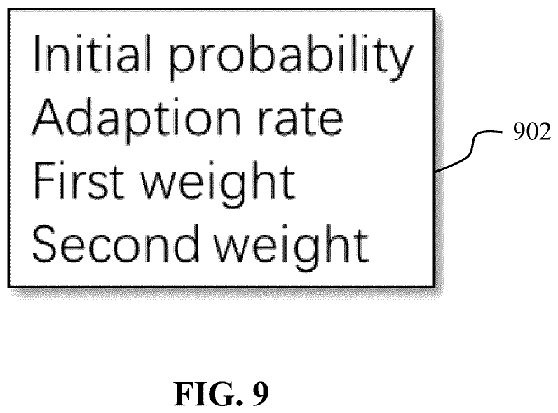

As an example, FIG. 9 shows a set of context model probability parameters 902, which contains initial probabilities, adaptation rates, and weights applied to two probabilities that are associated with two context models.

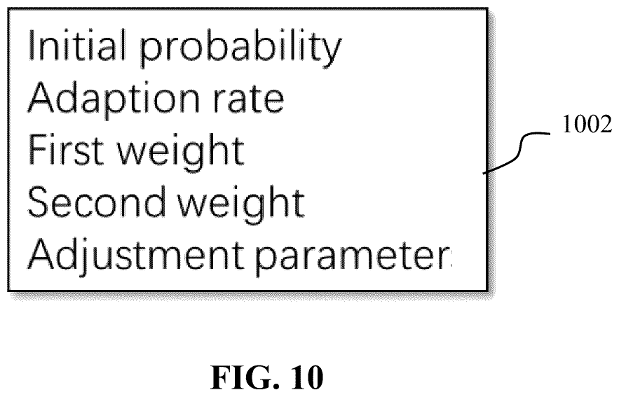

As another example, FIG. 10 shows a set of context model probability parameters 1002, which contains initial probability, adaptation rates, weights applied to two probabilities, adjustment parameters associated with each context model. It is noted that the adjustment parameters can be shared among the plurality of sets of context model probability.

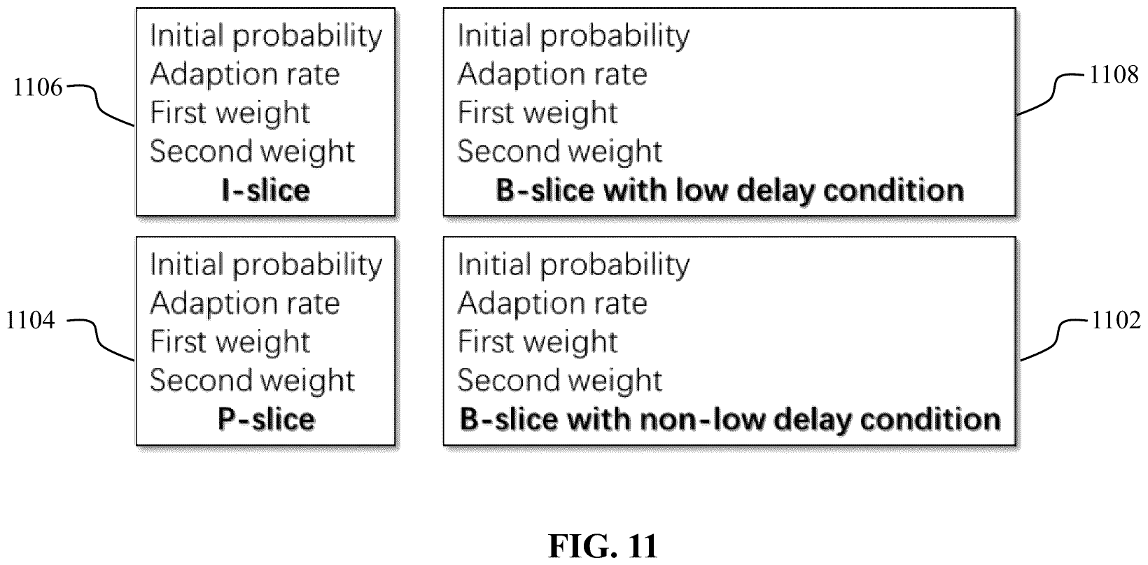

As another example, FIG. 11 shows four sets of predefined context model probability parameters including a first set of context model probability parameters 1102 for B-slice and non-low delay condition, a second set of context model probability parameters 1104 for P-slice, a third set of context model probability parameters 1106 for I-slice, and a fourth set of context model probability parameters 1108 for B-slice and low delay condition. For each slice, the context model probability is selected according to its slice type and low delay condition. This selection is derived at both encoder and decoder without signaling in the bitstream.

As another example, X+1 sets of context model probability parameters are pre-defined, where X is determined based on number of temporal ID. A first set of context model probability parameters for non-inter slice. A second set of context model probability parameters for inter slice with temporal ID equal to 0. A third set of context model probability parameters for inter slice with temporal ID equal to 1. Similarly, a k^{th} set of context model probability parameters for inter slice with temporal ID equal to k−2. For each inter slice, the set of context model probability parameters is selected according to temporal ID, whereas for non-inter slice, the first set of context model probability parameters is always used.

As another example, there are five sets of context model probability parameters including a first, a second, a third and a fourth sets pre-defined for I-slice, P-slice, B-slice with non-low delay condition and B-slice with low delay condition, respectively. The fifth set is predicted from previous coded pictures. For I-slice, the first set of context model probability parameters is used, whereas for non-I slice (i.e., inter slice), it is selected from the second, the third, the fourth and the fifth sets. The selection is based on rate cost. Rate costs are calculated using each set of context model probability parameters, and the set with minimum rate cost is used. A parameter for inter slice is signaled into bitstream to indicate which set of context model probability parameters is selected.

Similarly, in another example, there are five sets of context model probability parameters including a first, a second, a third and a fourth sets pre-defined for I-slice, P-slice, B-slice with non-low delay condition and B-slice with low delay condition, respectively. The fifth set is predicted from previous coded pictures. For inter slice, it can select whether to use the fifth set predicted from previous coded pictures. If it is determined to not use the fifth set, the set is selected according to slice type and low delay condition.

In some embodiments, it is proposed to select a set of context model probability parameters from a plurality of sets of context model probability parameters associated with each video sequence. The plurality of sets of context model probability parameters contain N sets, wherein N is a positive integer number. A set of context model probability parameters may contain any subset of {initial probability, adaptation rates, weights applied to two probabilities and adjustment parameters}. The selection may be signaled in a bitstream associated with the video sequence.

As an example, four sets of context model probability parameters are pre-defined. The four sets include: a first set of context model probability parameters for B-slice, a second set of context model probability parameters for P-slice, a third set of context model probability for I-slice, and a fourth set of context model probability parameters for B-slice. Each set of context model probability parameters contains initial probability, adaptation rates, and weights applied to two probabilities. The adjustment parameters are shared among (i.e., are the same for) the four sets of context model probability parameters. For each slice, the corresponding context model is determined according to its slice type. Moreover, a flag may be signaled at the SPS-level in bitstream to indicate which one of the first set or the fourth set of context model probability parameters is used for B-slice.

Similarly, in another example, each set of context model probability parameters contains initial probability, adaptation rates, weights applied to two probabilities, and adjustment parameters.

Similarly, in another example, the SPS-level flag signaled in bitstream to indicate which one of the first set or the fourth set of context model probability parameters is used for B-slice is determined according to low delay condition at encoder. If it is determined to be low delay condition, the fourth set of context model probability parameters is used to initiate the context model of B-slice, and the SPS-level flag is encoded to indicate that the fourth set of context model probability parameters is selected. Otherwise, if it is determined to be non-low delay condition, the first set of context model probability parameters is used to initiate the context model of B-slice, and the SPS-level flag is encoded to indicate that the first set of context model probability parameters is selected.

As another example, four sets of context model probability parameters are pre-defined. The four sets of context model probability parameters include: a first set of context model probability parameters for B-slice, a second set of context model probability parameters for P-slice, a third set of context model probability parameters for I-slice, and a fourth set of context model probability parameters for B-slice. Each set of context model probability parameters contains initial probability, adaptation rates, and weights applied to two probabilities. The adjustment parameters are shared among (i.e., are the same for) the four sets of context model probability. Moreover, for B- and P-slices, it is determined whether to predict their context models from previous coded pictures. In case that the context models for the B- and P-slices are not predicted from previous coded pictures, the second set of context model probability parameters is used for P-slice, and an SPS-level flag is signaled to indicate which one of the first set or the fourth set of context model probability parameters is used for B-slice. Otherwise, in case that the context models for the B- and P-slices are predicted from previous coded pictures, the pre-defined sets of context model probability parameters are not used. In contrast to the B- and P-slices, the I-slices always use the third set of context model probability parameters, without relying on previous coded pictures.

In some embodiments, in addition to or as an alternative to the SPS-level flag indicating which one of the first set or the fourth set of context model probability parameters is used for B-slice, a flag may be signaled at PPS-level, picture header, or slice header of a bitstream, to indicate which one of the first set or the fourth set of context model probability parameters is used for B-slice.

In some embodiments, there are N sets of context model probability parameters predefined for the I-slice type, P-slice type, and B-slice type. Three parameters are signaled to indicate which one(s) of the N sets of context model probability is/are used for the I-, P- and B-slice type, respectively.

In some embodiments, there are two sets of context model probability parameters predefined for each of the I-slice type, P-slice type, and B-slice type. For each slice type, a flag is signaled at SPS-level to indicate which one of the two sets associated with the respective slice type is used.

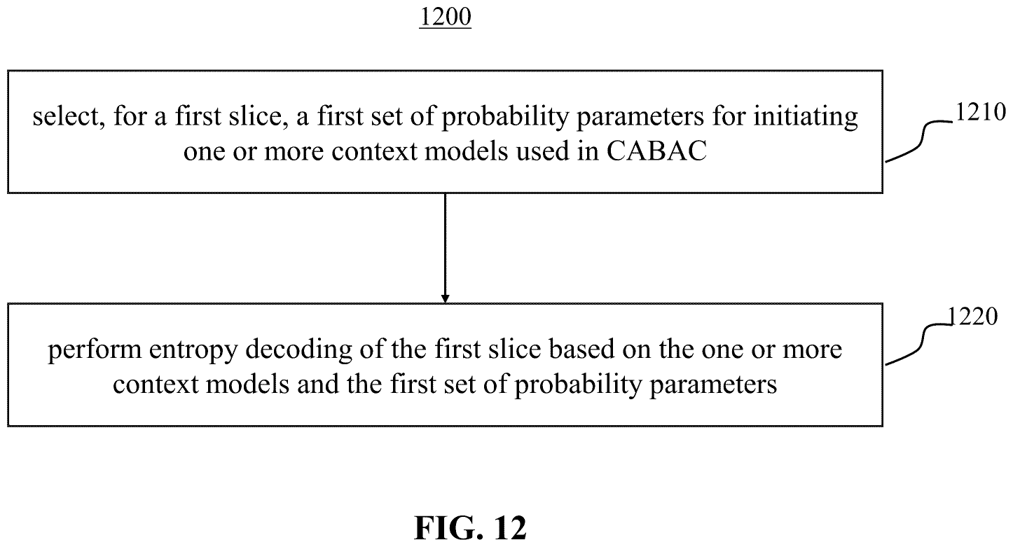

The above-described methods for initializing the probability parameters of context models can be performed in an encoder and a decoder. FIG. 12 illustrates a flowchart of an exemplary method 1200 for decoding a bitstream associated with a video, according to some embodiments of the present disclosure. Method 1200 can be performed by a decoder (e.g., by process 300A of FIG. 3A or 300B of FIG. 3B) or performed by one or more software or hardware components of an apparatus (e.g., apparatus 400 of FIG. 4), in performing CABAC. For example, one or more processors (e.g., processor 402 of FIG. 4) can perform method 1200. In some embodiments, method 1200 can be implemented by a computer program product, embodied in a computer-readable medium, including computer-executable instructions such as program code, executed by computers (e.g., apparatus 400 of FIG. 4). As shown in FIG. 12, method 1200 includes the following steps 1210-1220.

At step 1210, a processor (e.g., processor 402 of FIG. 4) selects, for a first slice, a first set of probability parameters for initiating one or more context models used in CABAC. The first slice can be a current slice that the processor is decoding. The first set of probability parameters can be selected from a plurality of predefined sets of probability parameters.

The selected first set of probability parameters can be used to initiate the context models. For example, two context models may be used to perform the CABAC. Before performing CABAC of a new slice, the processor needs to initiate the probability parameters used by the two context models.

FIG. 9 provides an example of a set of probability parameters. As shown in FIG. 9, the set of probability parameters 902 can include one or more of: an initial probability for use with one or more context models, an adaptation rate of the one or more context models, a plurality of weights that is respectively associated with a plurality of probabilities, or an adjusted probability for use with the one or more context models. The initial probability is an initial probability value used for a context model in the CABAC of a slice. If two context models are used in the CABAC, the set of probability parameters 902 may include two initial probabilities, one for each of the two context models. The adaptation rates is the rate for adapting the probability state of a context model. Again, if two context models are used in the CABAC, the set of probability parameters 902 may include two adaptation rates, one for each of the two context models. The weights are used for weighing the context models. If two context models are used in the CABAC, the set of probability parameters 902 may include two weights, one for each of the context models. Although the above description assumes two context models are used in the CABAC of a slice, it is possible that more context models (e.g., three or four) are used. In those case, the set of probability parameters 902 may include more initial probabilities, adaptation rates, and/or weights.

Moreover, after the CABAC of a slice starts, the initial probabilities of the context models can be adjusted. The set of probability parameters 1002 in FIG. 10 further includes one or more adjustment parameters. An adjustment parameter is an adjusted probability that can be used for a context model after the model initialization.

In some embodiments, the processor can select the first set of probability parameters from the plurality of predefined sets of probability parameters, without requiring explicit signaling. For example, the selection can be based on one or more of a slice type, a quantization parameter (QP), a temporal identifier, a low delay condition, or a rate cost associated with the first slice. Examples for making the selection based on these parameters are given above, which are not repeated herein.

Referring back to FIG. 12, at step 1220, the processor performs entropy decoding of the first slice based on the one or more context models and the first set of probability parameters.

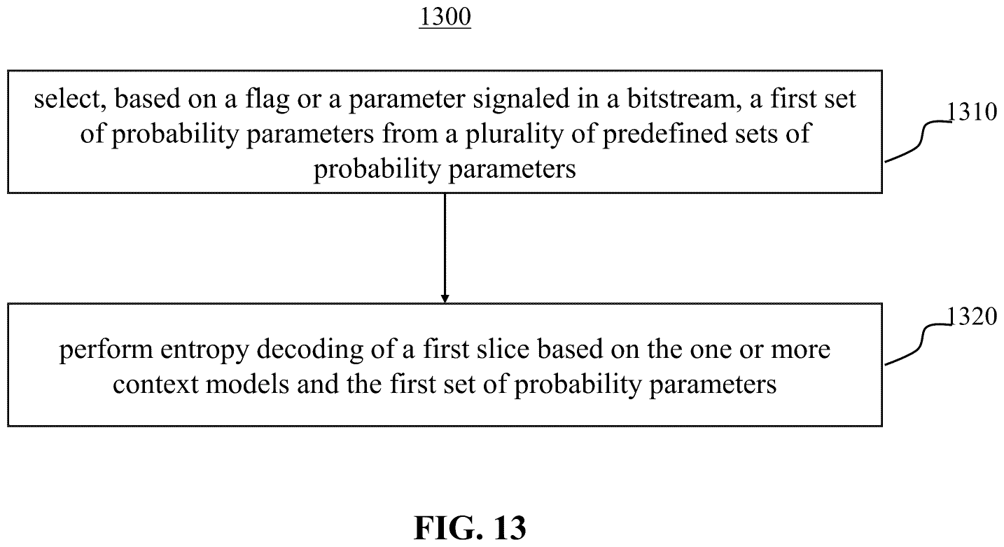

In some embodiments, the selection of the set of initial probability parameters can be signaled in a bitstream. FIG. 13 illustrates a flowchart of an exemplary method 1300 for decoding a bitstream associated with a video, according to some embodiments of the present disclosure. Method 1300 can be performed by a decoder (e.g., by process 300A of FIG. 3A or 300B of FIG. 3B) or performed by one or more software or hardware components of an apparatus (e.g., apparatus 400 of FIG. 4), in performing CABAC. For example, one or more processors (e.g., processor 402 of FIG. 4) can perform method 1300. In some embodiments, method 1300 can be implemented by a computer program product, embodied in a computer-readable medium, including computer-executable instructions such as program code, executed by computers (e.g., apparatus 400 of FIG. 4). As shown in FIG. 13, method 1300 includes the following steps 1310-1320.

At step 1310, a processor (e.g., processor 402 of FIG. 4) selects, based on a flag or a parameter signaled in a bitstream, a first set of probability parameters from a plurality of predefined sets of probability parameters. The first set of probability parameters are used for initiating the context model probabilities used in CABAC of a first slice.

For example, the flag can be signaled in an SPS, a PPS, a picture header, or a slice header. For example, if the flag is signaled in an SPS, the set of probability parameters referred to by the flag can be used for all the slices associated with the SPS.

As another example, the flag or parameter can have a value dependent on whether a low delay condition or a non-low delay condition is used for encoding the first slice. For example, if the low delay condition is enabled, a value of the flag or parameter (e.g., “2”) can refer to a first one of the plurality of predefined sets of probability parameters; and if the non-low delay condition is enabled, the same value of the flag or parameter (i.e., “2”) can refer to a second one of the plurality of predefined sets of probability parameters.

At step 1320, the processor performs entropy decoding of the first slice based on the one or more context models and the first set of probability parameters.

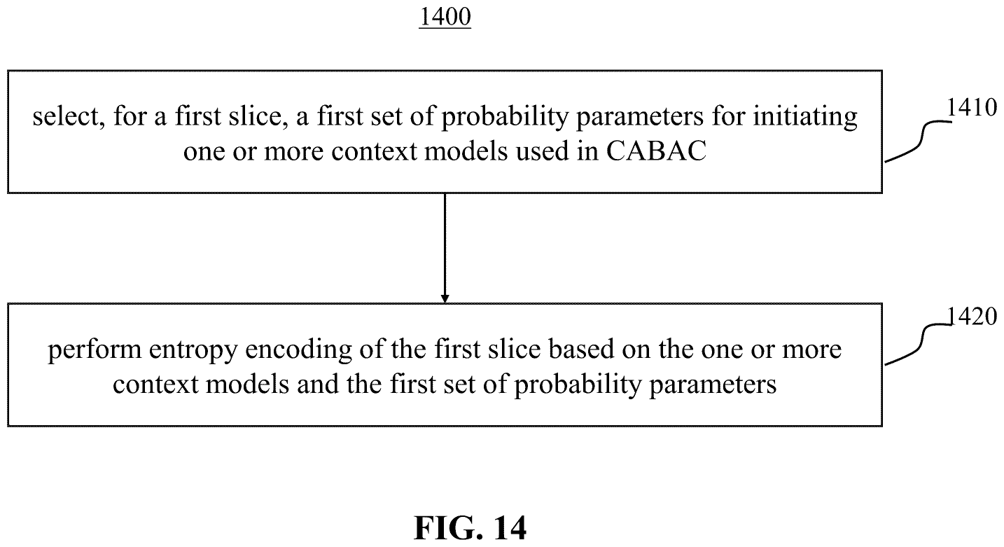

Encoding methods corresponding to the above-described decoding methods can be performed by an encoder. For example, FIG. 14 illustrates a flowchart of an exemplary method 1400 for encoding a bitstream associated with a video, according to some embodiments of the present disclosure. Method 1400 can be performed by an encoder (e.g., by process 200A of FIG. 2A or 200B of FIG. 2B) or performed by one or more software or hardware components of an apparatus (e.g., apparatus 400 of FIG. 4), in performing CABAC. For example, one or more processors (e.g., processor 402 of FIG. 4) can perform method 1400. In some embodiments, method 1400 can be implemented by a computer program product, embodied in a computer-readable medium, including computer-executable instructions such as program code, executed by computers (e.g., apparatus 400 of FIG. 4). As shown in FIG. 14, method 1400 includes the following steps 1410-1420.

At step 1410, a processor (e.g., processor 402 of FIG. 4) selects, for a first slice, a first set of probability parameters for initiating one or more context models used in CABAC. In some embodiments, the selecting can be based on at least one of a slice type, a quantization parameter (QP), a temporal identifier, a low delay condition, or a rate cost associated with the first slice.

At step 1420, the processor performs entropy encoding of the first slice based on the one or more context models and the first set of probability parameters.

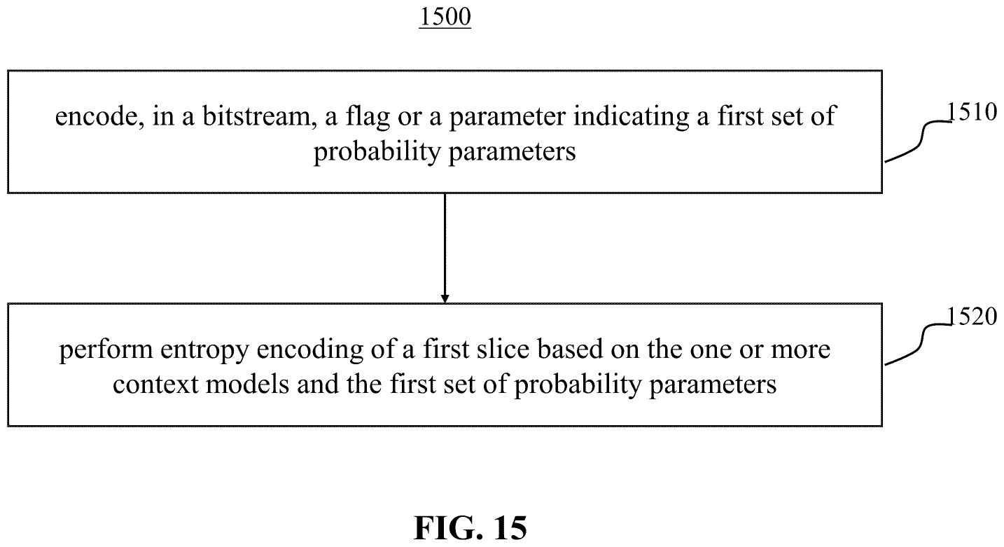

FIG. 15 illustrates a flowchart of an exemplary method 1500 for encoding a bitstream associated with a video, according to some embodiments of the present disclosure. Like method 1400, method 1500 can also be performed by a processor of an encoder. As shown in FIG. 15, method 1500 includes the following steps 1510-1520.

At step 1510, the processor encodes, in a bitstream, a flag or a parameter indicating a first set of probability parameters. The flag or parameter is associated with a slice, and signals that the first set of probability parameters is selected for performing CABAC of the first slice. The selection can be based on at least one of a slice type, a quantization parameter (QP), a temporal identifier, a low delay condition, or a rate cost associated with the first slice (step 1410 in FIG. 14).

Referring back to FIG. 15, at step 1520, the processor performs entropy encoding of the first slice based on the one or more context models and the first set of probability parameters.

It is noted that the disclosed methods can be combined freely.

In some embodiments, a non-transitory computer-readable storage medium storing a bitstream is also provided. The set of context model probability selected for a slice can be signaled in the bitstream.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The embodiments may further be described using the following clauses:
1. A method of decoding a bitstream associated with a video sequence, the method comprising:
selecting, from a plurality of predefined sets of probability parameters, a first set of probability parameters for initiating one or more context models for a B-slice; and
performing entropy decoding of the B-slice based on the one or more context models and the first set of probability parameters,
wherein the selecting is based on a coding condition of the B-slice or a signal in the bitstream.
2. The method according to clause 1, wherein the first set of probability parameters comprises at least one of:
an initial probability for use with the one or more context models,
an adaptation rate of the one or more context models,
a plurality of weights that is respectively associated with a plurality of probabilities, or
an adjusted probability for use with the one or more context models.
3. The method according to clause 1, wherein the coding condition comprises at least one of a quantization parameter (QP), a temporal identifier, a low delay condition, a non-low delay condition, or a rate cost associated with the first slice.
4. The method according to clause 1, wherein the signal comprises a flag or a parameter in the bitstream.
5. The method according to clause 4, wherein the selecting is based on a flag signaled in a sequence parameter set (SPS), a picture parameter set (PPS), a picture header, or a slice header.
6. The method according to clause 4, wherein the flag or parameter has a value dependent on whether a low delay condition or a non-low delay condition is used for encoding the B-slice.
7. The method according to clause 1, wherein the plurality of predefined sets of probability parameters comprises two predefined sets of probability parameters for the B-slice.
8. A method of encoding a bitstream associated with a video sequence, the method comprising:
selecting, from a plurality of predefined sets of probability parameters, a first set of probability parameters for initiating one or more context models for a B-slice; and
performing entropy encoding of the B-slice based on the one or more context models and the first set of probability parameters,
wherein the selecting is based on a coding condition of the B-slice or a signal in the bitstream.
9. The method according to clause 8, wherein the first set of probability parameters comprises at least one of:
an initial probability for use with the one or more context models,
an adaptation rate of the one or more context models,
a plurality of weights that is respectively associated with a plurality of probabilities, or
an adjusted probability for use with the one or more context models.
10. The method according to clause 8, wherein the coding condition comprises at least one of a quantization parameter (QP), a temporal identifier, a low delay condition, a non-low delay condition, or a rate cost associated with the first slice.
11. The method according to clause 8, further comprising:
encoding, in the bitstream, a flag or a parameter associated with the Bslice, the flag or parameter indicating that the first set of probability parameters is selected.
12. The method according to clause 11, wherein the flag is signaled in a sequence parameter set (SPS), a picture parameter set (PPS), a picture header, or a slice header.
13. The method according to clause 11, wherein the flag or parameter has a value dependent on whether a low delay condition or a non-low delay condition is used for encoding the first slice.
14. The method according to clause 8, wherein the plurality of predefined sets of probability parameters comprises two predefined sets of probability parameters for the B-slice.
15. A non-transitory computer readable storage medium storing a bitstream of a video for processing according to:
selecting, from a plurality of predefined sets of probability parameters, a first set of probability parameters for initiating one or more context models for a B-slice; and
performing entropy encoding or decoding of the B-slice based on the one or more context models and the first set of probability parameters,
wherein the selecting is based on a coding condition of the B-slice or a signal in the bitstream.
16. The non-transitory computer readable storage medium according to clause 15, wherein the first set of probability parameters comprises at least one of:
an initial probability for use with the one or more context models,
an adaptation rate of the one or more context models,
a plurality of weights that is respectively associated with a plurality of probabilities, or
an adjusted probability for use with the one or more context models.
17. The non-transitory computer readable storage medium according to clause 15, wherein the coding condition comprises at least one of a quantization parameter (QP), a temporal identifier, a low delay condition, a non-low delay condition, or a rate cost associated with the first slice.
18. The non-transitory computer readable storage medium according to clause 15, wherein the signal comprises a flag or a parameter in the bitstream.
19. The non-transitory computer readable storage medium according to clause 18, wherein the selecting is based on a flag signaled in a sequence parameter set (SPS), a picture parameter set (PPS), a picture header, or a slice header.
20. The non-transitory computer readable storage medium according to clause 18, wherein the flag or parameter has a value dependent on whether a low delay condition or a non-low delay condition is used for encoding the B-slice.
21. The method according to clause 15, wherein the plurality of predefined sets of probability parameters comprises two predefined sets of probability parameters for the B-slice.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method of decoding a bitstream associated with a video sequence, the method comprising:
selecting, from a plurality of predefined sets of probability parameters, a first set of probability parameters for initiating one or more context models for a B-slice; and
performing entropy decoding of the B-slice based on the one or more context models and the first set of probability parameters,
wherein the selecting is based on a coding condition of the B-slice or a signal in the bitstream.

2. The method according to claim 1, wherein the first set of probability parameters comprises at least one of:
an initial probability for use with the one or more context models,
an adaptation rate of the one or more context models,
a plurality of weights that is respectively associated with a plurality of probabilities, or
an adjusted probability for use with the one or more context models.

3. The method according to claim 1, wherein the coding condition comprises at least one of a quantization parameter (QP), a temporal identifier, a low delay condition, a non-low delay condition, or a rate cost associated with the first slice.

4. The method according to claim 1, wherein the signal comprises a flag or a parameter in the bitstream.

5. The method according to claim 4, wherein the selecting is based on a flag signaled in a sequence parameter set (SPS), a picture parameter set (PPS), a picture header, or a slice header.

6. The method according to claim 4, wherein the flag or parameter has a value dependent on whether a low delay condition or a non-low delay condition is used for encoding the B-slice.

7. The method according to claim 1, wherein the plurality of predefined sets of probability parameters comprises two predefined sets of probability parameters for the B-slice.

8. A method of encoding a bitstream associated with a video sequence, the method comprising:
selecting, from a plurality of predefined sets of probability parameters, a first set of probability parameters for initiating one or more context models for a B-slice; and
performing entropy encoding of the B-slice based on the one or more context models and the first set of probability parameters,
wherein the selecting is based on a coding condition of the B-slice or a signal in the bitstream.

9. The method according to claim 8, wherein the first set of probability parameters comprises at least one of:
an initial probability for use with the one or more context models,
an adaptation rate of the one or more context models,
a plurality of weights that is respectively associated with a plurality of probabilities, or
an adjusted probability for use with the one or more context models.

10. The method according to claim 8, wherein the coding condition comprises at least one of a quantization parameter (QP), a temporal identifier, a low delay condition, a non-low delay condition, or a rate cost associated with the first slice.

11. The method according to claim 8, further comprising:
encoding, in the bitstream, a flag or a parameter associated with the B-slice, the flag or parameter indicating that the first set of probability parameters is selected.

12. The method according to claim 11, wherein the flag is signaled in a sequence parameter set (SPS), a picture parameter set (PPS), a picture header, or a slice header.

13. The method according to claim 11, wherein the flag or parameter has a value dependent on whether a low delay condition or a non-low delay condition is used for encoding the first slice.

14. The method according to claim 8, wherein the plurality of predefined sets of probability parameters comprises two predefined sets of probability parameters for the B-slice.

15. A non-transitory computer readable storage medium storing a bitstream of a video for processing according to:
selecting, from a plurality of predefined sets of probability parameters, a first set of probability parameters for initiating one or more context models for a B-slice; and
performing entropy encoding or decoding of the B-slice based on the one or more context models and the first set of probability parameters,
wherein the selecting is based on a coding condition of the B-slice or a signal in the bitstream.

16. The non-transitory computer readable storage medium according to claim 15, wherein the first set of probability parameters comprises at least one of:
an initial probability for use with the one or more context models,
an adaptation rate of the one or more context models,
a plurality of weights that is respectively associated with a plurality of probabilities, or
an adjusted probability for use with the one or more context models.

17. The non-transitory computer readable storage medium according to claim 15, wherein the coding condition comprises at least one of a quantization parameter (QP), a temporal identifier, a low delay condition, a non-low delay condition, or a rate cost associated with the first slice.

18. The non-transitory computer readable storage medium according to claim 15, wherein the signal comprises a flag or a parameter in the bitstream.

19. The non-transitory computer readable storage medium according to claim 18, wherein the selecting is based on a flag signaled in a sequence parameter set (SPS), a picture parameter set (PPS), a picture header, or a slice header.

20. The non-transitory computer readable storage medium according to claim 15, wherein the flag or parameter has a value dependent on whether a low delay condition or a non-low delay condition is used for encoding the B-slice.
